(19) United States
(12) Patent Application Publication
(10) Pub. No.: US 2019/0162689 A1
(43) Pub. Date: May 30, 2019

(54) BIOLOGICAL SENSING DEVICE

(71) Applicants: LIANG-CHUAN LIU, NEW TAIPEI CITY (TW); MING-CHUN LEE, TAIPEI CITY (TW); SEN-MIAO CHEN, NEW TAIPEI CITY (TW)

(72) Inventors: LIANG-CHUAN LIU, NEW TAIPEI CITY (TW); MING-CHUN LEE, TAIPEI CITY (TW); SEN-MIAO CHEN, NEW TAIPEI CITY (TW)

(21) Appl. No.: 15/826,958

(22) Filed: Nov. 30, 2017

(51) Int. Cl. G01N 27/22; A01M 31/00

(52) U.S. Cl. CPC G01N 27/22; G01N 22/00; A01M 31/002

(57) ABSTRACT

A biological sensing device for sensing and estimating the presence of quantity of living things in a sensing space is disclosed to include a controller, a microprocessor, a power source and a sensing unit including an electrode set for creating electrostatic coupling in the sensing space and a sensor controlled by the controller to sense a capacitance change in the sensing space indicative of the presence and quantity of living things in the sensing space and to transmit a corresponding signal to the microprocessor for computing so that the microprocessor can estimate the presence and quantity of living things in the sensing space.

### BACKGROUND OF THE INVENTION

### 1. Field of the Invention

The present invention relates to biological sensing technology, and more particularly to a biological sensing device for use in a pest trap to detect the presence and quantity of living things in a sensing space in the pest trap.

### 2. Description of the Related Art

Conventional biological sensing device designs commonly adopt video or light blocking method to achieve sensing. The information it needs to process the image or optics generated by the sensing source is quite large. In consequence, these conventional biological sensing device designs need to use a largescale sensor element and a high-power processing unit. Since the largescale sensor and the high-power processing unit consume a lot of power, these conventional biological sensing device designs need to use a large battery, increasing the battery size and cost, and needing to frequently replace the battery.

Further, the application of light blocking method need to use a photointerrupter in a light path for detecting the passing of a living thing. This method can not truly detect the presence and quantity of living things in a specific area.

### SUMMARY OF THE INVENTION

The present invention has been accomplished under the circumstances in view. It is therefore the main object of the present invention to provide a biological sensing device, which is practical for sensing and estimating the presence and quantity of living things in a sensing space.

To achieve this and other objects of the present invention, a biological sensing device comprises a sensing unit, a controller, a microprocessor and a power source. The sensing unit comprises an electrode set for creating electrostatic coupling in a sensing space, and a sensor for sensing a capacitance change in the sensing space indicative of the presence of living things in the sensing space and transmitting a corresponding signal to the microprocessor. The microprocessor is adapted for receiving and computing the signal from the sensor to estimate the presence and quantity of living things in the sensing space. The controller is coupled with the sensing unit, and adapted for controlling the sensing unit to make sensing in one or multiple directions per every predetermined time interval to achieve high precision sensing and to save power consumption.

Preferably, the biological sensing device further comprises a memory for storing computed data provided by the microprocessor, and a wireless module controllable by the controller to transmit storage data from said memory to an external electronic device such as smart phone, tablet computer or remote host computer.

Further, in one embodiment of the present invention, the sensor is a capacitive sensor for sensing a capacitance change in the sensing space. Further, multiple sensing units can be installed and electrically coupled to the controller to improve sensing accuracy.

Further, the use of capacitive sensor to sense the change of capacitance in the sensing space, minimizing power consumption of the sensor and the microprocessor and prolonging the utilizing time of the battery of the power source.

Further, the sensor can be a capacitive sensor for sensing the change of capacitance, an inductive sensor for sensing the change of voltage or current, or a microwave sensor for sensing the change of wave frequency. The sensed signal is transmitted to the microprocessor for computing, so that the microprocessor can estimate the presence and quantity of living things in the sensing space.

### BRIEF DESCRIPTION OF THE DRAWINGS

FIG. 1 is a circuit block diagram of a biological sensing device in accordance with the present invention.

FIG. 2 illustrates the architecture of the biological sensing device in accordance with the present invention.

FIG. 3 is a schematic applied view of the present invention.

FIG. 4 illustrates multiple biological sensing devices installed in a sensing space in a container in accordance with the present invention.

FIG. 5 is a circuit block diagram of an alternate form of the biological sensing device in accordance with the present invention.

### DETAILED DESCRIPTION OF THE PREFERRED EMBODIMENT

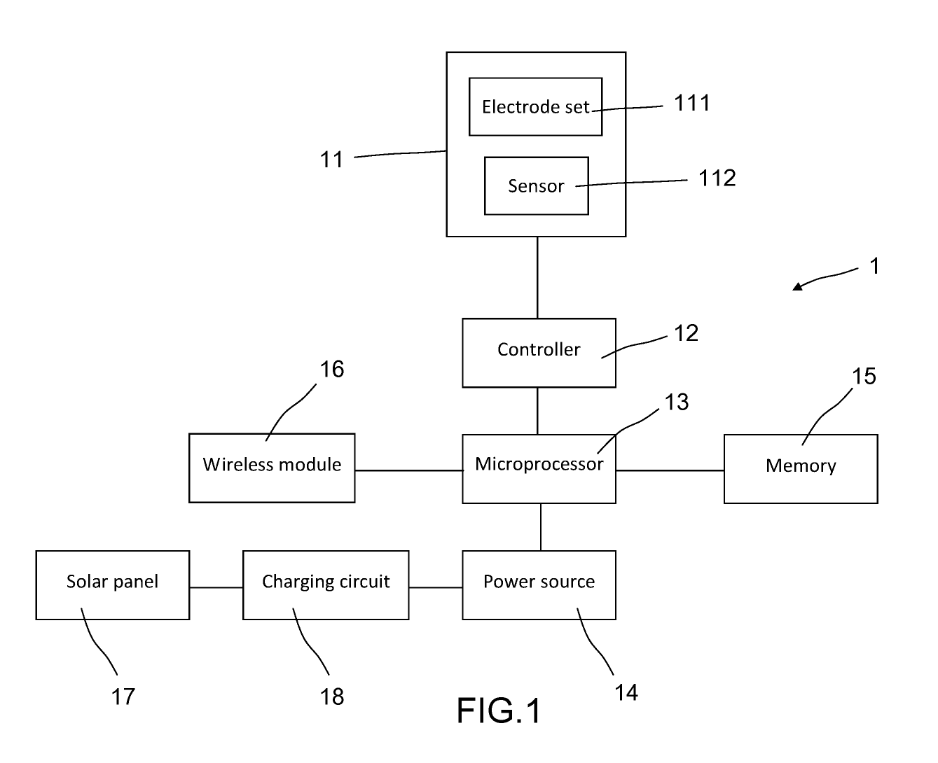

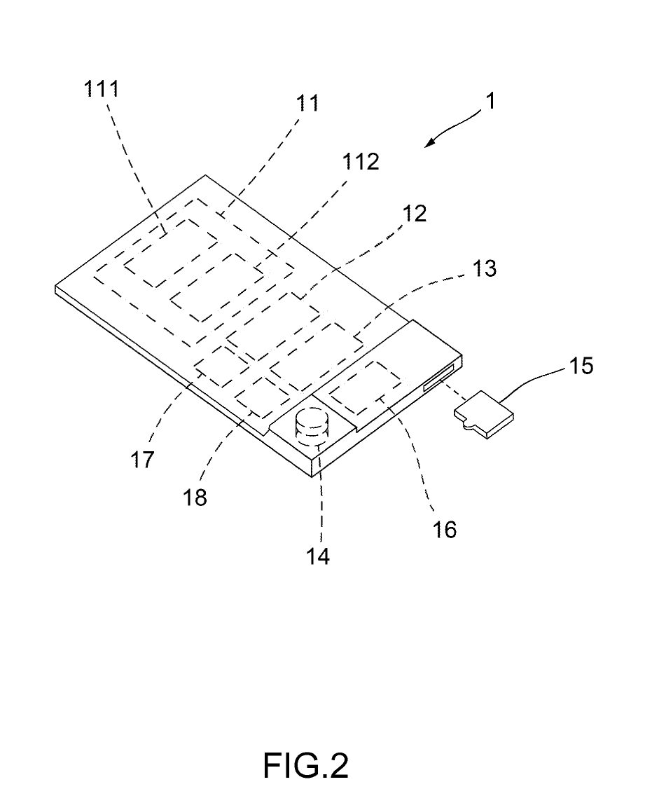

Referring to FIGS. 1-2, a biological sensing device (1) in accordance with the present invention is shown. The biological sensing device (1) comprises a sensing unit (11), a controller (12), a microprocessor (13) and a power source (14).

The sensing unit (11) comprises an electrode set (111) and a sensor (112). The electrode set (111) is used to produce electrostatic coupling in a sensing space (21). When living things are moving or staying in the sensing space (21), the electromagnetic field of the electrode set (111) is changed, causing the sensor (112) to detect a change in capacitance value and to transmit the detected capacitance value to the microprocessor (13) for computation, so that the microprocessor (13) can estimate the amount and status of living things in the sensing space (21). Further, the sensing unit (11) is controlled by the controller (12) to make detection in one direction or multiple directions per every predetermined time interval, saving power consumption. The biological sensing device (1) further comprises a charging circuit (18) and a solar panel (17). The solar panel (17) absorbs the sunlight as a source of energy to generate electricity for charging the power source (14) by the charging circuit (18).

The biological sensing device (1) further comprises a memory (15) and a wireless module (16). The data processed by the microprocessor (13) is stored in the memory (15). The memory (15) can be, for example, a replaceable memory card. Storage data can be fetched from the memory (15), and then transmitted by the wireless module (16) to an external mobile electronic apparatus such as smart phone, tablet computer or remote host computer.

Further, the sensor (112) can be a capacitive sensor for sensing the change of capacitance, an inductive sensor for sensing the change of voltage or current, or a microwave sensor for sensing the change of wave frequency. The sensed signal is transmitted to the microprocessor (13) for computing, so that the microprocessor (13) can estimate the presence and quantity of living things in the sensing space (21).

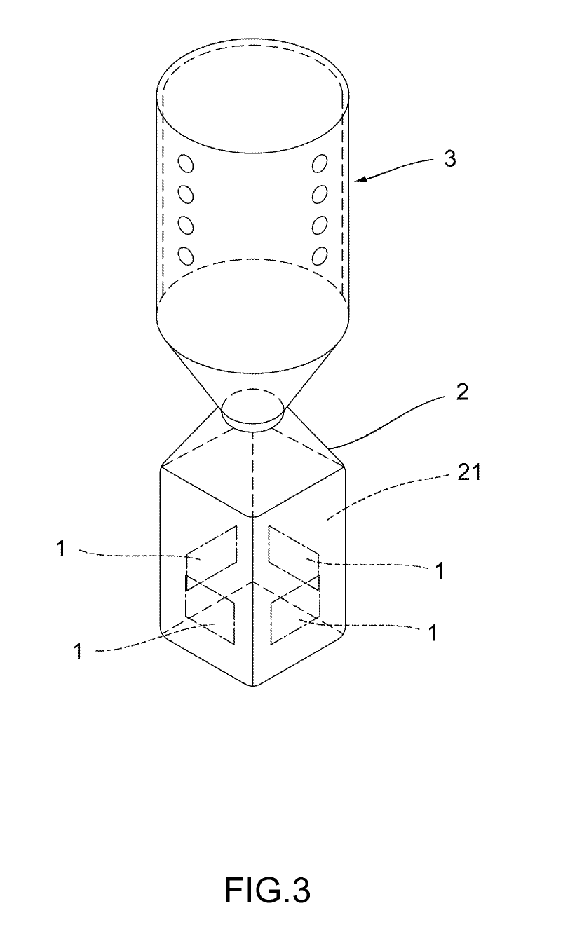

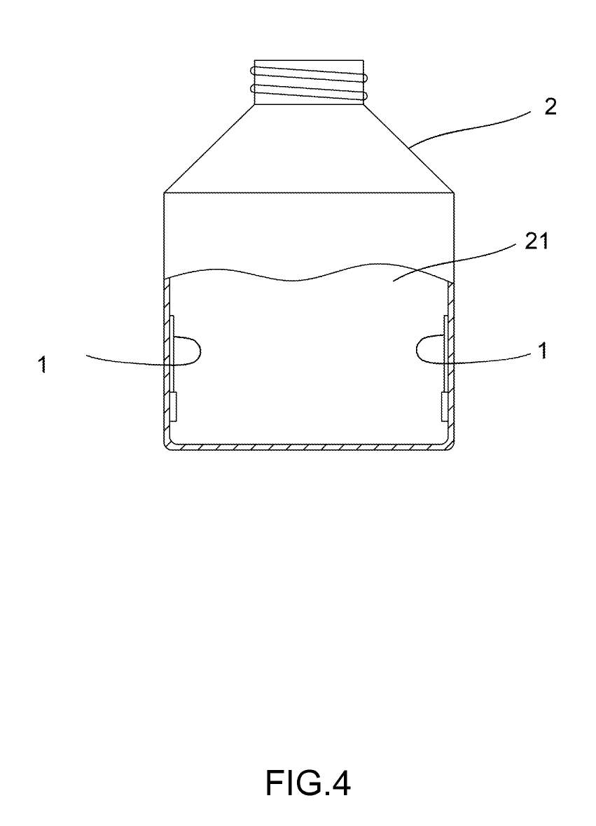

The biological sensing device (1) of the present invention can be used in a general biological trap device (3), for example, pest trap device (3), as illustrated in FIG. 3. In application, install one or multiple biological sensing devices (1) made in accordance with the present invention in a sensing space (21) inside a container (2), or on the inner wall or outer wall of a box. Once a living thing is lured into the trap device (3), it will be exhausted after a period of time and then descend into the container (2) or box that is provided with the biological sensing device (1), as illustrated in FIG. 4. When a living thing is moving in the sensing space (21) inside the container (2), the biological sensing device (1) detects a capacitance change and provides a corresponding signal to the microprocessor (13) for computation so that the microprocessor (13) can estimate the amount of status of living things in the sensing space (21).

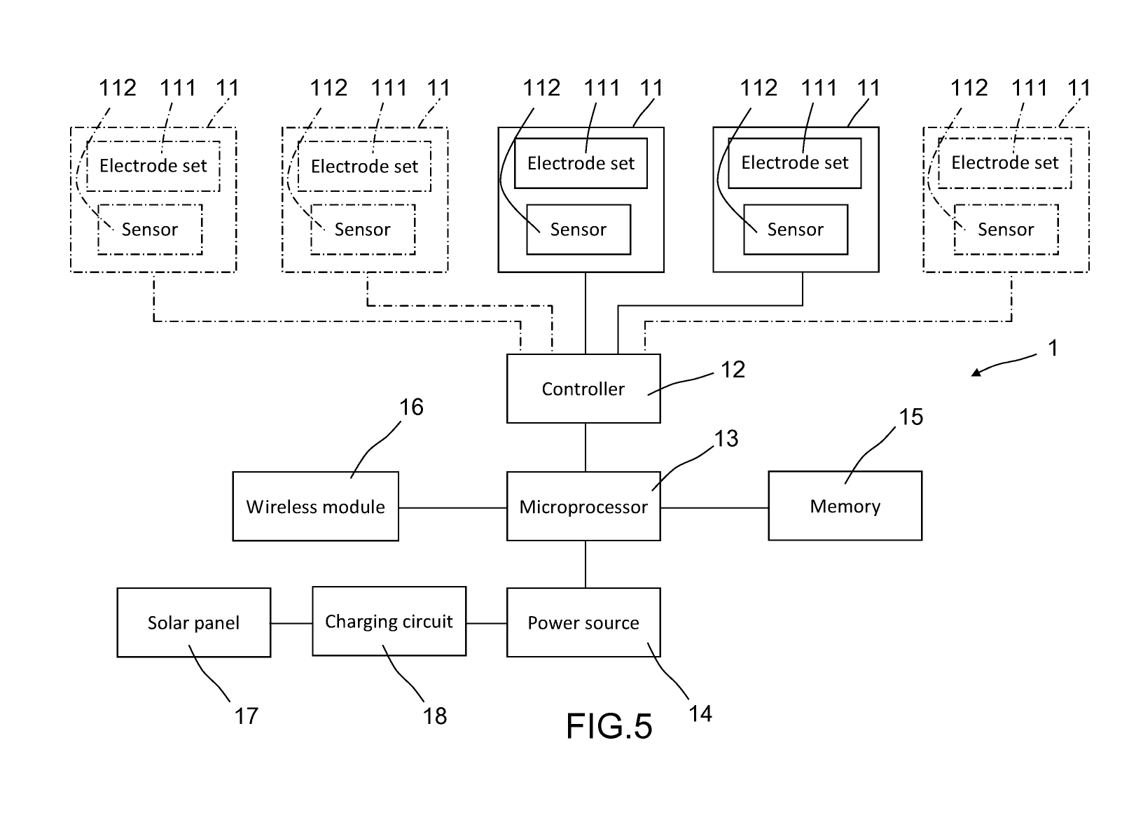

FIG. 5 illustrates an alternate form of the present invention. According to this alternate form, multiple sensing units (11) are installed and electrically coupled to the controller (12) to create a more subtle and multiple sensing of the sensing space (21) for more accurate data.

In summary, the present invention provides the effects of sensing accuracy improvement, device miniaturization and low power consumption, and the ability of truly sensing the presence and quantity of living things.

What the invention claimed is:

1. A biological sensing device, comprising at least one sensing unit, a controller, a microprocessor and a power source, each said sensing unit comprising an electrode set for creating electrostatic coupling in a sensing space and a sensor for sensing a capacitance change in said sensing space indicative of the presence of living things in said sensing space and transmitting a corresponding signal to said microprocessor, said microprocessor being adapted for receiving and computing the said signal from said sensor so as to estimate the presence and quantity of living things in said sensing space, said controller being coupled with said at least one sensing unit and adapted for controlling said at least one sensing unit to make sensing in one or multiple directions per every predetermined time interval.

2. The biological sensing device as claimed in claim 1, further comprising a memory for storing computed data provided by said microprocessor, and a wireless module controllable by said controller to transmit storage data from said memory to an external electronic device such as smart phone, tablet computer or remote host computer.

3. The biological sensing device as claimed in claim 1, wherein said sensor is an inductive sensor for sensing the change of voltage or current.

4. The biological sensing device as claimed in claim 1, wherein said sensor is a microwave sensor for sensing the change of wave frequency.

5. The biological sensing device as claimed in claim 1, further comprising a solar panel adapted for absorbing the sunlight as a source of energy to generate electricity, and a charging circuit for charging said power source with the electricity generated by said solar panel.

6. The biological sensing device as claimed in claim 1, wherein a plurality of said sensing units are installed and electrically coupled to said controller to implement multiple sensing.

7. The biological sensing device as claimed in claim 2, wherein memory is a replaceable memory card.
